(19) United States
(12) Patent Application Publication
(10) Pub. No.: US 2018/0326547 A1
(43) Pub. Date: Nov. 15, 2018

(54) ADDITIVE MANUFACTURING OF GEARS

(71) Applicant: THE GLEASON WORKS, Rochester, NY (US)

(72) Inventor: Hermann J. Stadtfeld, Webster, NY (US)

(21) Appl. No.: 15/774,132

(22) PCT Filed: Nov. 29, 2016
(86) PCT No.: PCT/US2016/063937

§ 371 Date: May 7, 2018

Related U.S. Application Data
(60) Provisional application No. 62/261,026, filed on Nov. 30, 2015.

(51) Int. Cl. B23P 15/14; B23K 26/342; F16H 55/02; B33Y 10/00; B33Y 80/00; B33Y 30/00

(52) U.S. Cl. CPC B23P 15/14; B23K 26/342; F16H 55/02; B23K 2101/008; B33Y 80/00; B33Y 30/00; B33Y 10/00

(57) ABSTRACT

A method of manufacturing gear teeth by additive manufacturing. Each tooth (20) is constructed from a predetermined number of layers (30, 31, 32) of material (e.g. steel) with each layer being formed by a predetermined number of rows (33-41) of material preferably applied by a welding head (13) or equivalent apparatus.

### FIELD OF THE INVENTION

The present invention is directed to the manufacture of gear teeth and in particular to additive manufacturing of gear teeth onto a cylindrical or conical base blank.

### BACKGROUND OF THE INVENTION

The term additive manufacturing is commonly used for 3-D printing of three-dimensional objects. 3-D printing was originally used primarily to manufacture prototypes which represented the geometrical shape and even the mechanical function of three-dimensional objects. The 3-D printed objects, however, usually consisted of a material with different physical properties than the replicated object. In addition, the material structure is defined by the adhesion process of layers of powder, usually plastic powder. The plastic powder is similar to the plastic pellets used in injection molding machines but with greatly reduced pellet size, down to a diameter of 50 μm or less. The adhesion of the powder particle layers is accomplished in a chemical process by a surrounding electrolyte with e.g. a negative charge and a positive charge of the printing powder. It is also possible to introduce heat locally into the printing zone and achieve a micro-melting of the printed material between the printing layers like in laser cladding. In later applications, the 3-D printing also employed metal powders, consisting for example of aluminum particles. In order to achieve good adhesion between the particle layers, a binder material is added to the layers and similar to a sintering process, a chemical connection of the particle surfaces and/or a physical adhesion is achieved. 3-D printed objects are very similar in their open pore structure to sintered objects but they lack the density of classic sintered materials. The classical sintering process requires high heat and high pressure. 3-D printing has only been possible with localized heat and without pressure.

Another additive manufacturing technology which has existed for more than a century is welding. Welding is used to connect different size parts from steel or other materials to complex structures with high material density and high strength on the welded interfaces. Welding of complex structures eliminates the costly metal removal processes which would be required on large and complex milling machines in order to manufacture the same structure from a solid, large piece of metal. Welding fabrications also eliminate waste in the form of chips and cutting oil.

Repair welding is also known for almost a century. It is used to replicate worn or damaged machine components such as shafts, cams, and even gear teeth. The repair welding achieves a melted bond between the host component and the added layer. If the welding rod or the electrode material is chosen correctly, then the chemical structure between the host material and the foreign repair layer are similar or even identical. Materials like steel allow some normalizing or tempering process or a cryogenic treatment in order to equalize the component structure between host component and added layer, such that the newly added material section shows the same physical properties as the original component. After such a treatment, the transition zone between the host component and the added layer is also similar or even identical in structure and density.

Electric arc welding techniques or laser welding with metal powder are also used to perform additive manufacturing not for the purpose of repair, but in order to create complete components or for the addition of geometrical shapes to larger base components. The machines used for this kind of additive manufacturing are similar to 5-axes milling machines which use pre-processed computer-aided design (CAD) models that allows them to automatically create the desired shapes, for example from standard carburizing steel, directly from the electronic part prints.

### SUMMARY OF THE INVENTION

The present invention is directed to a method of manufacturing gear teeth by additive manufacturing. Each tooth is constructed from a predetermined number of layers of material (e.g. steel) with each layer being formed by a predetermined number of rows of material preferably applied by a welding head or equivalent apparatus.

### BRIEF DESCRIPTION OF THE DRAWINGS

FIG. 1 shows an example of a multi axes machine tool for the manufacture of bevel and hypoid gears that is equipped with a welding head for performing additive manufacturing of gear teeth.

FIG. 2 illustrates a model of a bevel gear tooth consisting of columns and rows.

FIG. 3 shows the top and back side flank of a partial gear tooth depicting the inventive welding layer method.

FIG. 4 illustrates a welding head with its axis aligned with a surface normal vector.

FIG. 5 shows a cross-sectional view of a shaft having a toothed section.

FIG. 6 shows a disk shaped part with a recessed toothed section within the circumference of the larger part diameter.

### DETAILED DESCRIPTION OF THE PREFERRED EMBODIMENT

The terms “invention,” “the invention,” and “the present invention” used in this specification are intended to refer broadly to all of the subject matter of this specification and any patent claims below. Statements containing these terms should not be understood to limit the subject matter described herein or to limit the meaning or scope of any patent claims below. Furthermore, this specification does not seek to describe or limit the subject matter covered by any claims in any particular part, paragraph, statement or drawing of the application. The subject matter should be understood by reference to the entire specification, all drawings and any claim below. The invention is capable of other constructions and of being practiced or being carried out in various ways. Also, it is understood that the phraseology and terminology used herein is for the purposes of description and should not be regarded as limiting.

The details of the invention will now be discussed with reference to the accompanying drawings which illustrate the invention by way of example only. In the drawings, similar features or components will be referred to by like reference numbers. For a better understanding of the invention and ease of viewing, where appropriate, doors and any internal or external guarding have been omitted from the drawings.

The use of “including”, “having” and “comprising” and variations thereof herein is meant to encompass the items listed thereafter and equivalents thereof as well as additional items. The use of letters to identify elements of a method or process is simply for identification and is not meant to indicate that the elements should be performed in a particular order.

Although references may be made below to directions such as upper, lower, upward, downward, rearward, bottom, top, front, rear, etc., in describing the drawings, these references are made relative to the drawings (as normally viewed) for convenience. These directions are not intended to be taken literally or limit the present invention in any form unless explicitly specified. In addition, terms such as “first”, “second”, “third”, etc., are used to herein for purposes of description and are not intended to indicate or imply importance or significance unless explicitly specified.

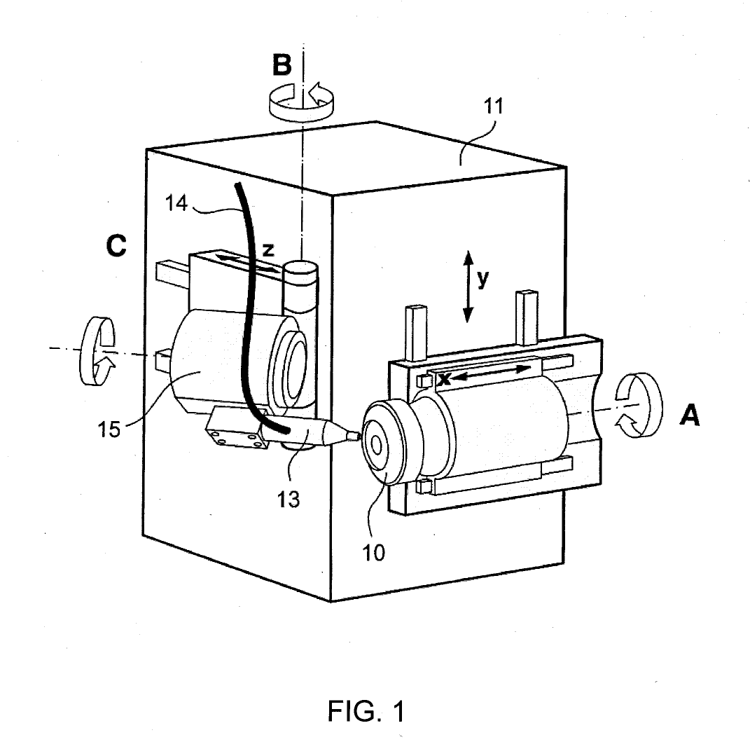

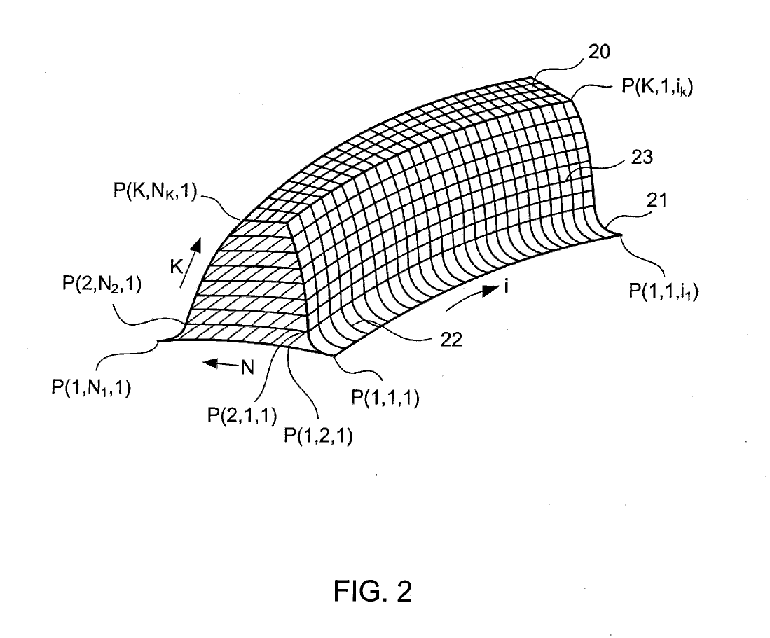

The present invention is directed to the additive manufacturing of gear teeth onto a base such as a cylindrical or conical base blank. FIG. 1 shows a gear workpiece blank 10 positioned on a multi-axis CNC machine such as a free form bevel gear cutting or grinding machine 11 (e.g. U.S. Pat. No. 6,712,566 incorporated herein by reference) or the blank 10 may be positioned on a three- to five-axes computer-controlled milling machine. A welding head 13, which is preferably designed for an arc welding process with an automatically fed welding rod 14 or for a laser welding process with an automatically dosed supply of suitable material, such as a steel rod or steel powder for example, is positioned on the non-rotatable (with respect to tool axis C) tool head or spindle housing 15. Preferably, the CNC machine pre-processor receives a digital model of a single tooth 20 (FIG. 2) which includes the root fillet 21 on each side of the tooth, although models of more than one tooth are also contemplated. Thus, the machine of FIG. 1 may perform conventional bevel gear manufacturing as well as additive manufacturing of gear teeth on a workpiece blank 10 which is rotatable about work axis A.

FIG. 2 shows a model of a bevel gear tooth 20 having a predetermined number of columns 22 and rows 23. The column points are numbered from 1 to i in direction “i” which is the direction along the rows. The layers are numbered from 1 to K in direction “K” and the rows are numbered from 1 to N in direction “N”. Thus, the points are numbered according to: (Layer K, Row N, Column i).

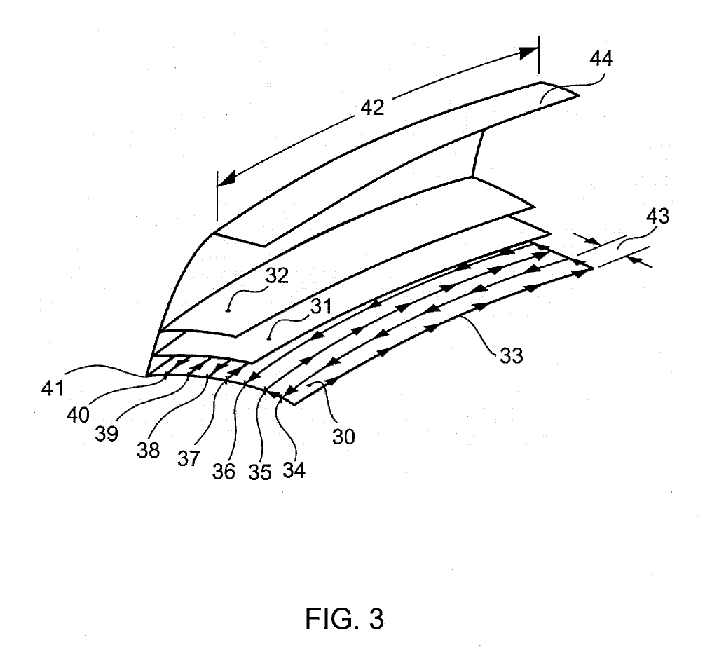

As seen in FIG. 3, the first and lowest layer is the root layer 30. The second layer 31 is partially shown. The third layer 32 is also partially shown. The topland 44 is the last layer. The welding begins with row 33. The distance between the first row 33 and the second row 34 is indicated by 43. The welding continues in the following order: Row 35, 36, 37, 38, 39, 40 and 41 in the directions indicated by the arrows. After finishing the lowest layer 30, the welding continues in layer 31, 32 and so on, until it reaches the topland 44 which is last layer.

Each layer 30, 31, 32 and so on consists two outer or surface rows (e.g. 33 and 41) and a number of inside rows (e.g. 34 to 40). The rows guide the welding head along the face width 42. The inside rows connect the first row (e.g. 33) of each layer with the last row (e.g. 41) of each layer. The inside rows lay on equidistant cylinders (cylindrical gears) or cones (bevel gears) and are located so as to preferably split the circular tooth thickness in equal distances. The distances are preferably equal to the welding width. In bevel gears, for example, if a change of the inside row distances between heel and toe is required, then the welding width can be controlled with the welding feed rate. The thickness of the layers is equal to the layer of material added in one pass.

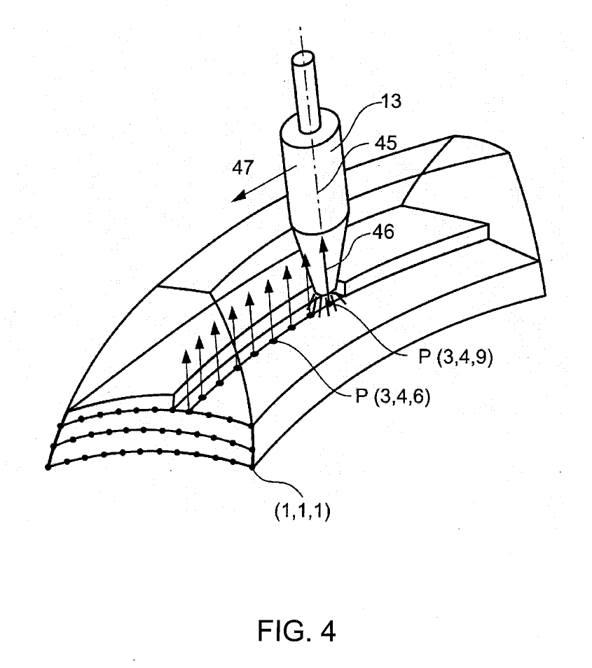

In FIG. 4 the theoretical welding head tip is shown positioned at a point, P(3,4,9) for example, and aligned with surface normal vector 46. The axis 45 of the welding head 13 is aligned with the surface normal vectors of the points along the path of welding head movement (e.g. P(3,4,6)). The welding head 13 moves with constant or variable speed in direction 47. The additive tooth manufacturing has completely finished the first two layers and partially finished the third layer.

As seen in FIGS. 2 and 3, the welding head may move first along the left flank surface from point P(1,1,1) to point P(1,1, i₁) (first row 33 in the first layer 30) from heel end to toe end and then moves back from the toe along the inside row 34 from point P(1,2,iᵢ) to point P(1,2,1). Next, the welding moves from the heel to the toe along row 35 and back to the heel along row 36. This repeats until row 41 is reached. In case of an even number of N rows in one layer, the welding head will arrive at the heel at the end of welding one layer (e.g. point P(1,N₁,1)). At this point the welding head moves to the next layer 31 and follows the row that begins with point P(2, N₂,1) and ends with point P(2, N₂, i₂) from heel to toe. As it arrives at the toe, it returns to the heel along the row which begins with point P(2,N₂−1,i₂) and ends with point P(2, N₂−1,1). This cycle repeats until the welding head arrives at row P(2,1,1) at the heel in case of an even number of rows N. This procedure repeats for the third layer, fourth layer and so forth to the final layer K. The layer K represents the topland of the tooth, which concludes the additive manufacturing of one single tooth.

The remaining teeth of the manufactured gear can now be added by repeating the procedure of manufacturing tooth number 1 after the blank has been rotated by one pitch.

The surface rows can be welded with lower feed rates of the welding head 13 combined with a lower feed rate of the welding material (e.g. wire) in connection with optimized electrical current and electrical frequency. The objective of optimized surface row parameters is to achieve best possible surface density and surface finish.

The welding head axis 45 is initially aligned with the surface normal vector (e.g. 46). In order to optimize the dynamic effects of the row welding kinematics, the welding head axis can be tilted in different locations along a row with different angles (in the direction of or against the welding head moving direction). This tilt angle is in a plane which includes the welding head moving velocity and the surface normal vector.

For welding the surface rows, the welding head can be tilted in addition to the described tilt plane (with the arc pointing slightly to the outside (or inside) of the tooth. This is done in order to improve surface density and surface finish

In order to reduce internal stresses in the new formed gear and also reduce heat affected distortions it is possible to weld each row layer for tooth number 1 and then for tooth number 2, and additional teeth if any, until each tooth has this layer. Then the procedure is repeated for the next layer on all teeth. With this method, all teeth are built up simultaneously.

The surface rows consist of a certain number of discrete points along the row (columns). The inside rows can be calculated by using the same polar coordinates of the surface row points (column by column). The angular location of the inside layer points can be calculated for each column of each row by dividing the angular difference of the corresponding surface points in a certain number of equal differences. Depending on the welding width, the number of inside rows has to change layer by layer, because of the changing tooth thickness between layer 1 and layer K. It is desirable to change the number of inside rows because this will achieve an overlap of the rows between the different layers and reduce seam weakening of the newly built material structure.

It is possible to use different material for the additive manufactured teeth than the material of the blank. It is also possible to change the material composition (different steel alloys) between the core of the teeth and the surfaces.

Depending on the application of the additive manufactured gear teeth, a finishing operation may be required. After heat treatment, consisting of case carburizing for example, lapping may be applied. In cases where hard finish machining is desirable, such as with a prototyping process or low quantity manufacturing process similar to the additive manufacturing of the gear teeth, then a dedicated 5-axes gear tooth milling process (e.g. U.S. Pat. No. 8,967,926 incorporated herein by reference) may be employed in order to perform a hard finish operation, such as grinding or skiving for example, on the same machine which performed the additive tooth manufacturing.

In some cases, conventional manufacturing of the teeth is not possible. Part designs which require a one-piece part for strength reasons are often prohibitive because the manufacture with traditional subtractive manufacturing methods is impossible.

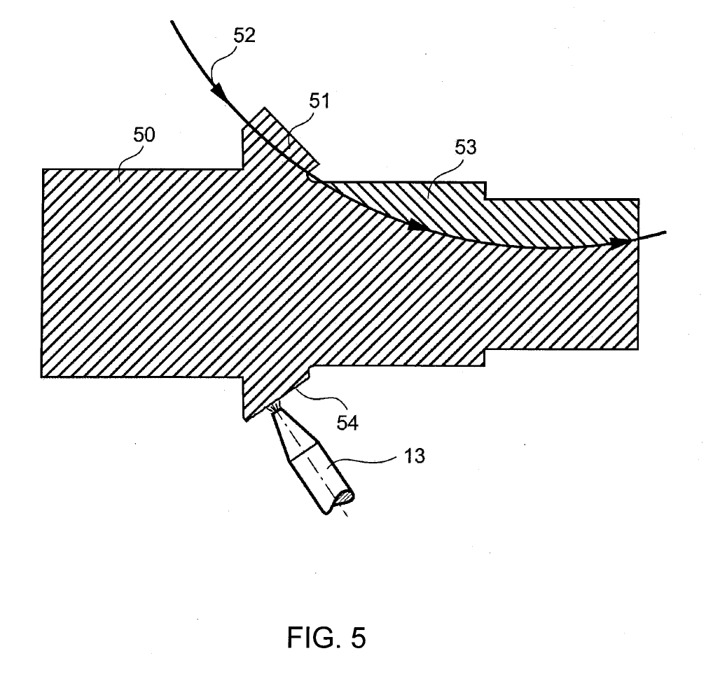

In a first example, FIG. 5 shows a cross-sectional view of a shaft 50 with a toothed section 51. The conventional subtractive manufacturing (e.g. face milling) of the toothed section 51 requires a circular cutter whose blade tips follow the arc 52. The conventional process cannot be applied in the case of part 50 because the circular tool track interferes with the part of the shaft 53 which is in front of the toothed area. The lower portion of FIG. 5 shows the root cone of the gear 54 without the excess material for subtractive slot cutting. Instead the welding head 13 adds the shape of the tooth by applying the inventive method.

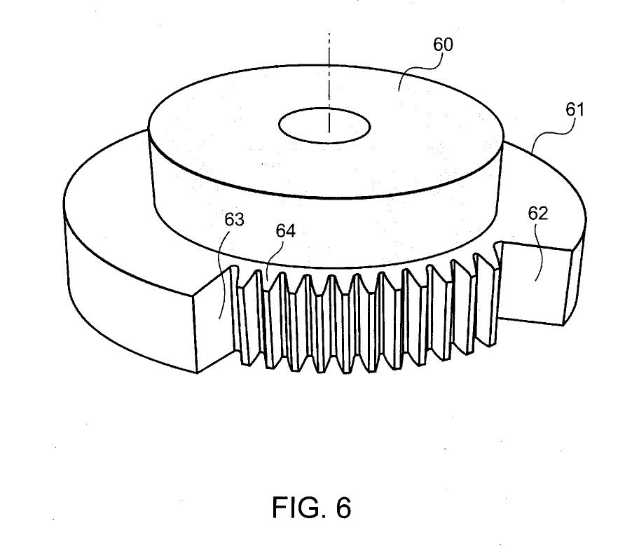

In another example, FIG. 6 shows a disk-shaped part 60 with a recessed section on the circumference of the larger diameter 61. The recess begins with step 62 and ends with step 63. The toothed section 64 which is between the steps 62 and 63 cannot be manufactured with a commonly used subtractive hobbing or shaping process since these processes will interfere with the segment limiting steps 62 and 63. It is possible to apply the inventive additive tooth manufacturing process in order to create the toothed section 64.

If the coarse surface structure from the welding process is not permissible for the final application, then a finish milling in accordance with previously mentioned U.S. Pat. No. 8,967,926 presents an optimal process complement to the inventive additive tooth manufacturing.

The inventive method is applicable to both cylindrical (e.g. spur and helical gears) as well as bevel gears including straight, spiral, hypoid and face or crown gears. The inventive method is likewise applicable to external and internal gears. Alternatively, the inventive method may also be carried out by laser cladding. Furthermore, the inventive method is applicable for the repair or replacement of broken, partially-broken, cracked, worn or otherwise damaged or marred gear teeth as can be appreciated by the artisan. In the case of damaged or partially-broken teeth, for example, it can be seen that the “base” on which a tooth is manufactured may be an existing or remaining portion (e.g. structurally-sound portion) of the damaged or partially-broken tooth.

Although the invention has been discussed and illustrated with respect to additive manufacturing of gear teeth, other elements of the gear structure or other elements of a workpiece comprising one or more gear teeth, integral with or remote from the gear teeth, may also be manufactured according to the inventive process.

While the inventive method has been discussed above with respect to the application of material being performed in the direction of the rows (direction i and direction −i), the invention is not limited thereto. Alternatively, although less preferred, material may be applied in the N direction (plus and minus). In either case, however, material is preferably applied by rows in a repeated back-and-forth manner (e.g. ±i or ±N) to form each layer.

While the invention has been described with reference to preferred embodiments it is to be understood that the invention is not limited to the particulars thereof. The present invention is intended to include modifications which would be apparent to those skilled in the art to which the subject matter pertains.

What is claimed is:

1. A method of forming a gear tooth by additive manufacturing, said method comprising:
applying a first layer of gear tooth material to a base, said first layer comprising two outer rows of said material and inside rows of said material extending between said outer rows,
applying one or more successive layers of gear tooth material on said first layer, each of said successive layers comprising two outer rows of said material and inside rows of said material extending between said outer rows, said one or more successive layers including a final successive layer defining a topland of said gear tooth.

2. The method of claim 1 wherein the outside rows and the inside rows are applied in the lengthwise direction of said gear tooth.

3. The method of claim 1 further comprising a finishing operation on the additive manufactured gear tooth.

4. The method of claim 1 wherein said base comprises a gear blank.

5. The method of claim 1 wherein said base comprises a partial gear tooth.

6. The method of claim 1 wherein said applying comprises welding.

7. The method of claim 6 wherein said welding is conducted with a welding head having a welding head axis and moving in a welding direction.

8. The method of claim 7 wherein the welding head axis is oriented to be aligned with a tooth surface normal vector.

9. The method of claim 7 wherein the welding head axis is oriented to be tilted in a plane defined by a tooth surface normal vector and the welding direction.

10. The method of claim 1 wherein the material of said first layer and the material of said successive layers are the same as the base.

11. The method of claim 1 wherein the material of at least one of said first layer and said successive layers is different than the base.

12. The method of claim 1 wherein the material of the outside rows is applied at a lower feed rate than the feed rate at which material of the inside rows is applied.

13. A multi-axis machine operable to manufacture a gear, said machine comprising:
a rotatable workpiece spindle,
a rotatable tool spindle,
a plurality of axes of movement whereby a tool positioned on said tool spindle and a workpiece positioned on said workpiece spindle are movable with respect to one another to manufacture a gear,
said machine further comprising an additive manufacturing apparatus operable to produce a gear tooth, said apparatus being operable via said plurality of axes of movement to apply a first layer of gear tooth material to a base, said first layer comprising two outer rows of said material and inside rows of said material extending between said outer rows;
said apparatus being further operable via said plurality of axes of movement to apply one or more successive layers of gear tooth material on said first layer, each of said successive layers comprising two outer rows of said material and inside rows of said material extending between said outer rows, said one or more successive layers including a final successive layer defining a topland of said gear tooth.

14. The machine of claim 13 wherein said additive manufacturing apparatus is positioned on a housing located about said tool spindle, said housing being non-rotatable with respect to the rotatable tool spindle.

15. The machine of claim 13 wherein said additive manufacturing apparatus comprises a welding head.
